(19) United States
(12) Patent Application Publication
(10) Pub. No.: US 2014/0349796 A1
(43) Pub. Date: Nov. 27, 2014

(54) GUIDE FOR FLEXIBLE TRANSMISSION MEMBER

(71) Applicant: TSUBAKIMOTO CHAIN CO., Osaka (JP)

(72) Inventors: Yudai Takagi, Osaka-shi (JP); Masahiko Konno, Osaka-shi (JP)

(73) Assignee: TSUBAKIMOTO CHAIN CO., Osaka (JP)

(21) Appl. No.: 14/283,268

(22) Filed: May 21, 2014

(30) Foreign Application Priority Data
May 27, 2013 (JP) 2013-111373

(51) Int. Cl. F16H 7/18

(52) U.S. Cl. CPC F16H 7/18; F16H 2007/185
USPC 474/140

(57) ABSTRACT

Provided is a chain guide that offers improved assembly efficiency by a more easily engageable interlock structure, operates more quietly by reducing noise caused by collision between mating parts and looseness of the shoe, and improves durability by reducing wear and fatigue of the mating parts. A lateral interlock structure formed by hole parts 121 and mating protrusions 161 restricts relative displacement of the base 110 and the shoe 150. An opposite interlock structure formed by a groove part 131 and mating protrusions 171 restricts relative displacement of the base 110 and the shoe 150 in the height direction. The mating protrusions 161 and 171 are elastic mating elements. The lateral interlock structure and the opposite interlock structure are a snap-fit joint in which a meshed state is achieved through elastic deformation of the mating protrusions 161 and 171 that occurs in a moving process during assembly.

### BACKGROUND OF THE INVENTION

1. Field of the Invention

The present invention relates to a guide for a flexible transmission member, in which a shoe in sliding contact with a running flexible transmission member and a base that supports the shoe are joined together by an interlock structure.

The guide is, for example, a chain guide in sliding contact with a chain which is a flexible transmission member and used, for example, for a timing wrapping transmission system used in a car engine.

2. Description of the Related Art

In some conventional guides for a flexible transmission member having a shoe with a running surface in sliding contact with a running flexible transmission member and a base with a support surface for supporting the shoe, it is known that the base and shoe are joined together with an interlock structure formed by a base-side mating part of the base and a shoe-side mating part of the shoe (see, for example, Column 6, Line 17 to Column 7, Line 18, and FIG. 5 to FIG. 8 of Japanese Examined Utility Model Application Publication No. 7-36201, and Paragraphs 0019 to 0021 and FIG. 1 to FIG. 5 of Japanese Patent Application Laid-open No. 2006-250208).

### SUMMARY OF THE INVENTION

In a guide for a flexible transmission member, for example a chain guide that has a base and a shoe connected with an interlock structure, the shoe is attached to the base by engagement between a plurality of base-side mating parts and a plurality of corresponding shoe-side mating parts in different directions relative to the guide, such as the combination of the longitudinal direction and height direction of the guide, or the combination of the width direction and the longitudinal direction of the guide. In some guides, the engagement is achieved by twisting the shoe around a center line along the longitudinal direction of the guide. The assembling is largely manual and cumbersome, because of which the assembling efficiency of the guide was poor and the cost was increased.

For facilitating the engagement between the respective base-side mating parts and shoe-side mating parts to attach the shoe to the base as described above, there is provided a clearance in the longitudinal direction of the guide between the base-side mating part and the shoe-side mating part meshing with each other (hereinafter referred to as “clearance for assembling”). This clearance for assembling is different from a gap for tolerating (hereinafter referred to as “tolerance for thermal expansion and contraction”) a difference in the amount of expansion and contraction between the base and shoe (hereinafter referred to as “difference in thermal expansion and contraction”), which is a difference in the amount of expansion between the base and shoe based on their thermal expansion coefficients (namely, thermal expansion, hereinafter, thermal expansion of the base and shoe will be referred to as “thermal expansion”), or a difference in the amount of contraction (namely, thermal contraction, hereinafter, thermal contraction of the base and shoe will be referred to as “thermal contraction”, and thermal expansion and contraction will be collectively termed as “thermal expansion and contraction”) that may occur due to friction heat generated between the running chain and the shoe in sliding contact therewith, or due to temperature changes of the environment in which the guide is used (for example, engine).

The guide is designed with tolerance for thermal expansion and contraction, which is a predetermined gap at normal temperature. “Normal temperature” is a normal temperature as defined by the Japanese Industrial Standards.

With such clearance for assembling, there are more gaps in the longitudinal direction in mating parts meshing with each other, so that when the shoe, which is in sliding contact with the chain running with varying speeds and vibration, displaces in the longitudinal direction because of friction with the chain, the mating parts collide against each other with more force. The guide produces more noise because of this collision sound, and also, the mating parts suffer accelerated wear and fatigue so that the durability of the mating parts is lowered, which in turn lowers the durability of the guide.

Any gap in the height direction between the base-side mating part and shoe-side mating part may cause the shoe to locally separate from the guide, or lift up, in the height direction of the guide because of possible chain looseness due to tension fluctuations or vibration, resulting in looseness of the shoe as well. Such shoe looseness increases noise in the guide, and accelerates wear and fatigue in the mating parts.

The present invention is directed to solve the problems above. An object of the invention is to provide a guide for a flexible transmission member, which allows easier engagement between a base-side mating part and a shoe-side mating part to join the base and shoe to offer improved assembling efficiency. Due to reduced clearance for assembling in the engagement between the base-side and shoe-side mating parts, and due to prevention of shoe looseness, the guide has better quiet operation performance, as noises resulting from collision between mating parts and from shoe looseness are suppressed. Moreover, as the mating parts suffer less collision-induced wear and fatigue, the guide offers higher durability.

Another object of the present invention is to provide a guide for a flexible transmission member that operates more quietly by reducing noise generated by shoe looseness particularly during thermal expansion of the base and the shoe.

To solve the problems described above, the present invention provides a guide for a flexible transmission member, including a base having a support surface and a pair of lateral rims positioned on both sides of the support surface in a width direction, and a shoe having a running surface in sliding contact with a running flexible transmission member and a pair of lateral edges positioned on both sides of the running surface in the width direction, the base and the shoe being joined together by an interlock structure formed by a base-side mating part of the base and a shoe-side mating part of the shoe so that the support surface supports the shoe on a backside of the shoe. The base-side mating part includes one or more base-side lateral mating parts provided in the lateral rims of the base, and a support-side mating part provided in the support surface. The shoe-side mating part includes one or more shoe-side lateral mating parts provided in the lateral edges of the shoe, and a backside mating part provided in the backside. The base-side lateral mating part and the shoe-side lateral mating part that mesh with each other form a lateral interlock structure, and the support-side mating part and the backside mating part that mesh with each other form an opposite interlock structure. The lateral interlock structure in the meshed state restricts relative displacement between the base and the shoe at least in a longitudinal direction of the longitudinal direction and a height direction, and the opposite interlock structure in the meshed state restricts relative displacement between the base and the shoe in the height direction. At least one of the base-side lateral mating part and the shoe-side lateral mating part and at least one of the support-side mating part and the backside mating part are elastic mating parts having one or more elastically deformable elastic mating elements. The lateral interlock structure and the opposite interlock structure are a snap-fit joint in which the meshed state is achieved through elastic deformation of the elastic mating elements that occurs in a moving process during assembly in which the shoe moves relative to the base in the height direction to be attached to the base.

In connection with the present invention, a “longitudinal direction” refers to a longitudinal direction of the guide for a flexible transmission member, which is a direction along the running surface of the shoe extending along the running direction of the flexible transmission member. A “width direction” refers to the width direction of the guide, which is orthogonal to an imaginary plane. A “height direction” refers to the height direction of the guide, which is orthogonal to a tangential direction of the longitudinal direction, and to the width direction, on the imaginary plane. Here, the “imaginary plane” is a plane orthogonal to the running surface and parallel to the longitudinal direction.

“Above” or “higher” refers to one side of the height direction where the running surface is located as seen from the support surface, and “below” or “lower” refers to the opposite side.

A “lateral width” refers to a width in the width direction.

“Relative displacement of the shoe in the height direction toward the base” refers to at least one of the mode in which the shoe approaches the base in the height direction, and the mode in which the base approaches the shoe in the height direction.

The guide for a flexible transmission member according to the present invention includes a base having a support surface and a pair of lateral rims positioned on both sides of the support surface in a width direction, and a shoe having a running surface in sliding contact with a running flexible transmission member and a pair of lateral edges positioned on both sides of the running surface in the width direction. The base and the shoe are joined together by an interlock structure formed by a base-side mating part of the base and a shoe-side mating part of the shoe so that the support surface supports the shoe on a backside of the shoe. The shoe is thus attached to the base by engagement between the base-side mating part of the base and the shoe-side mating part of the shoe, whereby the guide for a flexible transmission member having the base and shoe integrally joined is provided, as well as the following advantages characteristic to the present invention can be achieved.

Namely, according to the guide for a flexible transmission member of the present invention, the base-side mating part includes one or more base-side lateral mating parts provided in the lateral rims of the base, and a support-side mating part provided in the support surface, while the shoe-side mating part includes one or more shoe-side lateral mating parts provided in the lateral edges of the shoe, and a backside mating part provided in the backside. The base-side lateral mating part and the shoe-side lateral mating part that mesh with each other form a lateral interlock structure, while the support-side mating part and the backside mating part that mesh with each other form an opposite interlock structure. The lateral interlock structure in the meshed state restricts relative displacement between the base and the shoe at least in a longitudinal direction of the longitudinal direction and a height direction, while the opposite interlock structure in the meshed state restricts relative displacement between the base and the shoe in the height direction. At least one of the base-side lateral mating part and the shoe-side lateral mating part and at least one of the support-side mating part and the backside mating part are elastic mating parts having one or more elastically deformable elastic mating elements. The lateral interlock structure and the opposite interlock structure are a snap-fit joint in which the meshed state is achieved through elastic deformation of the elastic mating elements that occurs in a moving process during assembly in which the shoe moves relative to the base in the height direction to be attached to the base. As the lateral interlock structure and the opposite interlock structure are both a snap-fit joint, the base-side mating part and the shoe-side mating part can be engaged with each other by pressing the shoe to the base in the height direction in the moving process during assembly, by the effect of elastic deformation of the respective elastic mating elements of the lateral and opposite interlock structures. The shoe can therefore be attached to the base easily, and such assembling can also be automated, so that the assembling efficiency of the guide will be increased, and the cost of the guide can be reduced.

Since the base-side mating part and the shoe-side mating part are completely meshed with each other only by moving the base and the shoe relative to each other in the height direction, there need be substantially no clearance, or much less clearance than conventionally given, for the assembling purpose between the base-side mating part and the shoe-side mating part in the longitudinal direction. Moreover, the lateral interlock structure restricts relative displacement between the shoe and the base in the longitudinal direction, and thereby suppresses collision sounds that would be generated by displacement of the shoe in the longitudinal direction during the running of the flexible transmission member if there were clearance for assembling between the lateral mating parts. Furthermore, the opposite interlock structure restricts relative displacement between the shoe and the base in the height direction (prevents the shoe from lifting up), and thereby suppresses rattling sounds caused by loose shoe during the running of the flexible transmission member. As the noise resulting from clearance for assembling between the base-side lateral mating part and shoe-side lateral mating part and the noise resulting from shoe looseness are both reduced, the guide can operate more quietly.

The support-side mating part and the backside mating part that stop the shoe from lifting up are provided to the support surface of the base and the backside of the shoe, respectively, so that elevation of the shoe, or separation of its backside from the support surface, can be directly restricted. Since the support surface and the backside are relatively wider in the width direction as compared to the lateral rims of the base or lateral edges of the shoe, the support-side mating part and the backside mating part can be located in the width direction and designed relatively freely. With the high degree of freedom in designing the support-side mating part and backside mating part to increase the effect of preventing shoe elevation, the interlock structures can offer higher effect of preventing shoe looseness and of suppressing looseness-induced noises.

Suppression of collision resulting from clearance for assembling also reduces wear on the base-side lateral mating part and shoe-side lateral mating part due to the collision. Moreover, since the interlock structure that restricts shoe elevation is the opposite interlock structure that is separate from the lateral interlock structure, the lateral interlock structure suffers less stress than its counterpart in a guide in which the shoe is constrained in the longitudinal direction and stopped from lifting up only by the lateral interlock structure. The base-side lateral mating part and shoe-side lateral mating part suffer less wear and fatigue in this respect, too, so that the durability of the base and shoe, or the durability of the guide itself, can be improved.

According to the configuration set forth in claim 2, one of the lateral interlock structure and the opposite interlock structure is configured to press the shoe against the support surface by increasing a mating force in the height direction when the base and the shoe expand thermally, and the other structure is configured to press the shoe against the support surface by increasing the mating force in the height direction when the base and the shoe contract thermally. When thermally expanded, one of the lateral interlock structure and opposite interlock structure presses the shoe on the support surface with the increased mating force, while, when thermally contracted, the other structure presses the shoe on the support surface with the increased mating force. In this way, whether expanded or contracted under heat, shoe elevation is prevented and therefore shoe looseness is prevented.

According to the configuration set forth in claim 3, at least one of the lateral rims of the base includes a guide part that guides the shoe along the height direction while restricting displacement of the shoe relative to the base in the longitudinal direction and in the width direction in the moving process during assembly. In the moving process during assembly, the guide part provided to the lateral rim of the base guides the shoe moving along the height direction such as not to be misaligned in the longitudinal direction and in the width direction relative to the base, thus facilitating engagement of the snap-fit joint each made by the lateral interlock structure and opposite interlock structure. The shoe is thus easily attached to the base with the interlock structure.

According to the configuration set forth in claim 4, the base-side lateral mating part is formed by one or more base-side lateral mating elements, and the shoe-side lateral mating part is formed by shoe-side lateral mating elements as the elastic mating elements in a same number as the base-side lateral mating elements. The shoe-side lateral mating element includes a first mating portion and a second mating portion that mesh with the base-side lateral mating elements at a position higher than the running surface. The first mating portion in the meshed state abuts on the base-side lateral mating element from below to increase a mating force on the base-side lateral mating element when the base and the shoe expand thermally. The second mating portion in the meshed state abuts on the base-side lateral mating element from above to increase a mating force on the base-side lateral mating element in cooperation with the opposite interlock structure when the base and the shoe contract thermally. During thermal expansion, the reaction force to the mating force of the first mating portion abutting the base-side lateral mating element from below presses the shoe against the support surface to stop the shoe from lifting up. During thermal contraction, the mating force of the second mating portion abutting the base-side lateral mating element from above, and the mating force in the opposite interlock structure, restrict the shoe movement in the height direction relative to the base. This way, shoe looseness is prevented either way, whether expanded or contracted under heat.

Since the first and second mating portions are provided to one shoe-side lateral mating element, there need be a fewer number of shoe-side lateral mating element than in the case where the first and second mating portions are provided to separate shoe-side lateral mating elements, which can contribute to a simpler structure and weight reduction of the base and shoe.

According to the configuration set forth in claim 5, the pair of lateral rims of the base include notches recessed downwards, each notch being formed by stepped portions in the height direction and a bottom part continuous with the stepped portions and extending in the longitudinal direction. The bottom part is the base-side lateral mating element. The second mating portion that meshes with the base-side lateral mating element at a position higher than the first mating portion is located inside the notch. As a result, since the notches are each formed by the stepping portions in the height direction and the bottom part is the base-side lateral mating element, the second mating portion positioned higher than the first mating portion in the shoe-side lateral mating element is located inside the notch. Consequently, the shoe-side lateral mating element protrudes less by the length of the stepping portions, or does not protrude at all, upward relative to the base-side lateral mating element, so that the guide can be made smaller in the height direction. The lateral rims of the base are made more lightweight by formation of the notches, and the shoe-side lateral mating elements are made smaller in the height direction, so that the base and shoe are made more lightweight.

According to the configuration set forth in claim 6, the base-side lateral mating part is formed by one or more first base-side lateral mating elements and second base-side lateral mating elements that are the base-side lateral mating elements. The shoe-side lateral mating part is formed by first shoe-side lateral mating elements as the elastic mating elements in a same number as the first base-side lateral mating elements, and second shoe-side lateral mating elements that are the shoe-side lateral mating elements. The first shoe-side lateral mating element each meshes with the first base-side lateral mating element in the height direction from an inner side in the width direction, and abuts on the first base-side lateral mating element from below in the meshed state to increase the mating force on the first base-side lateral mating element when the base and the shoe expand thermally. The first mating portion meshes with the second base-side lateral mating element in the height direction from an outer side in the width direction. The first shoe-side lateral mating element and the first mating portion mesh with the first base-side lateral mating element and the second base-side lateral mating element from above and below from opposite sides in the width direction, so that, during thermal expansion, even if the mating force lowers in one of the first shoe-side lateral mating element and the first mating portion because of a reduction in mating area in the width direction due to a difference in the amount of thermal expansion and contraction between the base and shoe in the width direction, such reduction in mating area in the width direction due to a difference in the amount of thermal expansion and contraction in the width direction does not occur in the other of the first shoe-side lateral mating element and the first mating portion, i.e., a certain mating area in the width direction is secured. Thus shoe elevation is prevented during thermal expansion, and shoe looseness is prevented.

According to the configuration set forth in claim 7, the support-side mating part is formed by one or more groove parts including a slit forming a slit space open to the support surface and extending in the longitudinal direction, and a receiving part continuous with the slit in the height direction and extending in the longitudinal direction. The receiving part is formed by a plurality of wide receiving portions and a plurality of narrow receiving portions having a smaller lateral width than the wide receiving portions, the wide receiving portions and the narrow receiving portions being arranged alternately along the longitudinal direction. The backside mating part is formed by one or more mating protrusions as the elastic mating elements including a shoe-side opposite mating portion received in the receiving part, and a support part connected to the backside and supporting the shoe-side opposite mating portion. The slit has a smaller lateral width than the shoe-side opposite mating portion. The narrow receiving portion has a size in the width direction that is set such as to allow the shoe-side opposite mating portion received in the narrow receiving portion to contact the narrow receiving portion in the width direction. The shoe-side opposite mating portion, when positioned in the receiving part after elastic deformation by contact with the slit in the moving process during assembly, restricts upward movement of the shoe by engagement with the groove part, and is movable in the longitudinal direction inside the one or more wide receiving portions or the one or more narrow receiving portions when the shoe expands or contracts thermally. The mating protrusion thus meshes with the groove part, as the shoe-side mating portion comes to be located inside the receiving part after touching the groove part and deforming elastically, whereby shoe elevation is prevented and therefore shoe looseness is prevented.

The narrow receiving portion allows the shoe-side opposite mating portion to move in the longitudinal direction while being in contact therewith. Therefore, when the bead 172 and the narrow receiving portion 138 are in contact with each other, the shoe is stopped from moving in the longitudinal direction, which may result from clearance for accommodating thermal expansion and contraction in the lateral interlock structure, during the running of the flexible transmission member. Therefore, the lateral mating parts meshing with each other do not collide against each other, and even if they do, the impact of collision is reduced, so that collision sounds and wear on lateral mating parts are reduced.

If there is a large difference in the amount of thermal expansion and contraction, the shoe can move across the wide or narrow receiving portions in the longitudinal direction, so that breakage of the shoe or base due to thermal expansion or contraction can be prevented.

According to the configuration set forth in claim 8, the groove part is formed continuously over an entire length of the support surface in the longitudinal direction. The wide receiving portion forms a spherical wide receiving space, and the shoe-side opposite mating portion is a semi-spherical bead having a spherical surface on one side thereof in the width direction. In the spherical wide receiving space, a semi-spherical space is formed on the opposite side in the width direction from the spherical surface of the shoe-side opposite mating portion, so that lubricating oil entering into the groove part to lubricate the flexible transmission member or guide can flow smoothly in the groove part, and can cool the base and shoe more efficiently, leading to better cooling performance of the guide (i.e., speedy cooling of the guide).

### BRIEF DESCRIPTION OF THE DRAWINGS

FIG. 1 is a perspective view of a chain guide, illustrating Embodiment 1 of the present invention;

FIG. 2 is a side view of the chain guide of FIG. 1 viewed from a width direction;

FIG. 3 is a partly omitted plan view along a longitudinal direction of the chain guide of FIG. 1 viewed from a height direction;

FIG. 4 is a cross section along the line 4-4 of FIG. 3;

FIG. 5 is an enlarged view of essential parts of FIG. 4;

FIG. 6 is a cross section along the line 6-6 of FIG. 5;

FIG. 7 is a cross section along the line 7-7 of FIG. 5;

FIG. 8 is a schematic plan view illustrating a variation example of Embodiment 1 of the present invention;

FIG. 9 is a diagram corresponding to FIG. 8, illustrating another variation example of Embodiment 1 of the present invention;

FIG. 10 is a diagram corresponding to FIG. 2, illustrating Embodiment 2 of the present invention;

FIG. 11 is a diagram of Embodiment 2 corresponding to FIG. 8;

FIG. 12 is a cross section along the line 12-12 of FIG. 11;

FIG. 13 is a diagram corresponding to FIG. 2, illustrating Embodiment 3 of the present invention;

FIG. 14 is a diagram of Embodiment 3 corresponding to FIG. 8;

FIG. 15 is a cross section along the line 15-15 of FIG. 14; and

FIG. 16 is a diagram corresponding to FIG. 5, illustrating Embodiment 4 of the present invention.

### DESCRIPTION OF THE PREFERRED EMBODIMENTS

In the guide according to the present invention, one or both of the base-side lateral mating part and shoe-side lateral mating part may be an elastic mating part, and one or both of the support-side mating part and backside mating part may be an elastic mating part. Some of the mating elements that form the elastic mating part may be elastic mating elements, and the rest of the mating elements may constitute a snap-fit joint together with elastic mating elements included in the corresponding mating parts.

The flexible transmission member is a flexible component that transmits power by running, such as, for example, a chain or a belt. The guide is either a movable guide movably attached to a mounting target to apply tension to the flexible transmission member, or a fixed guide fixedly attached to the mounting target.

The transmission having the guide of the present invention may be used in car motors (including engines), as well as other motors (including engines), industrial machines, transfer machines, and so on.

### Embodiments

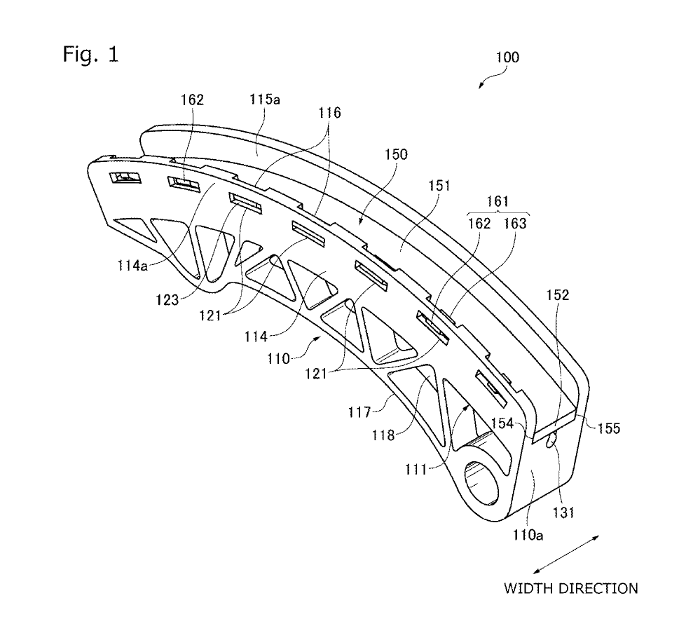

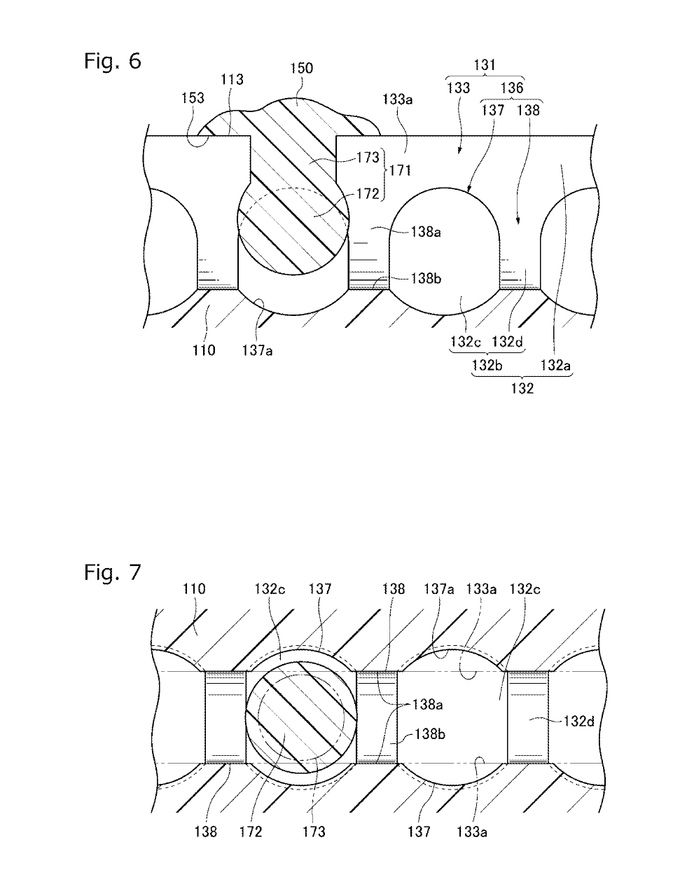

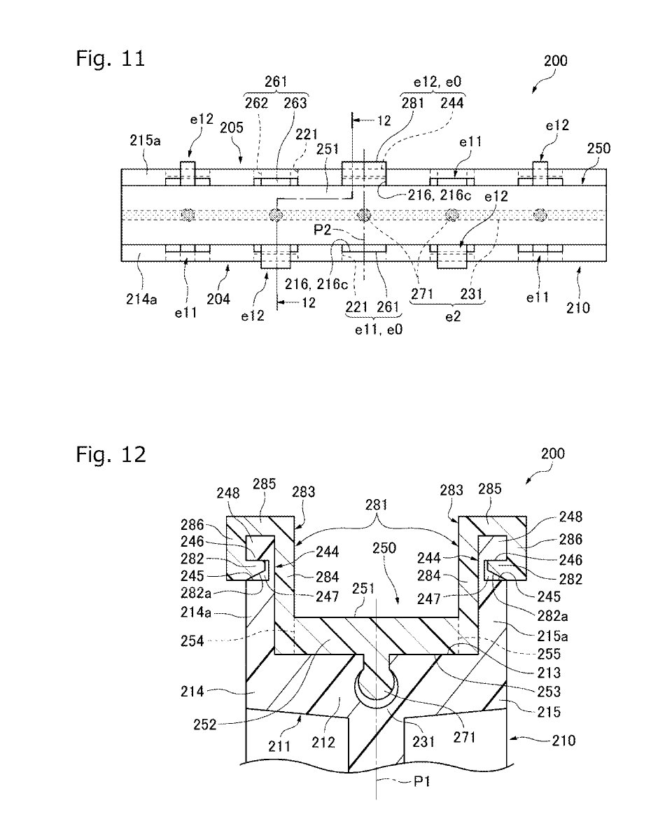

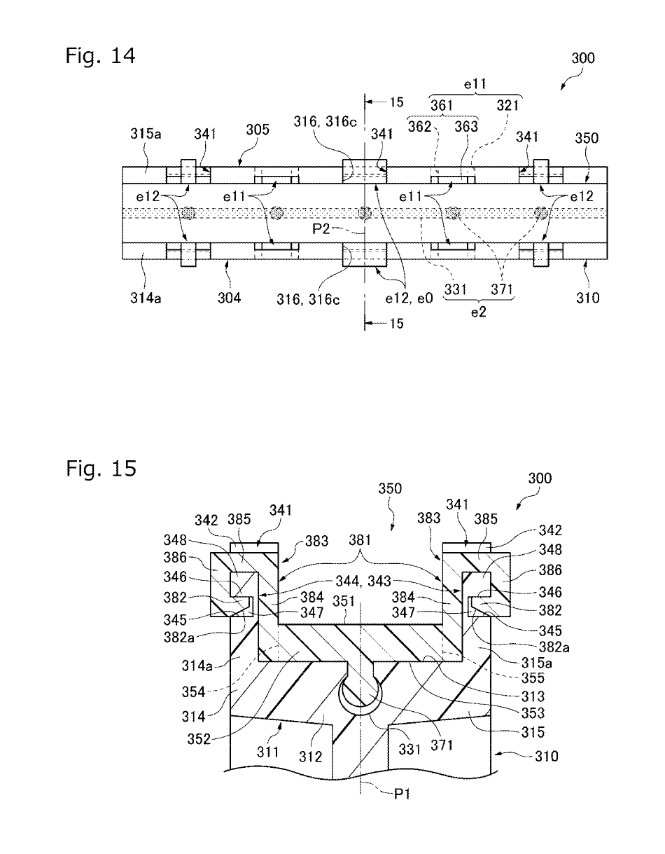

Hereinafter, embodiments of the present invention will be described with reference to FIG. 1 to FIG. 16.

FIG. 1 to FIG. 7 are diagrams for explaining Embodiment 1 of the present invention.

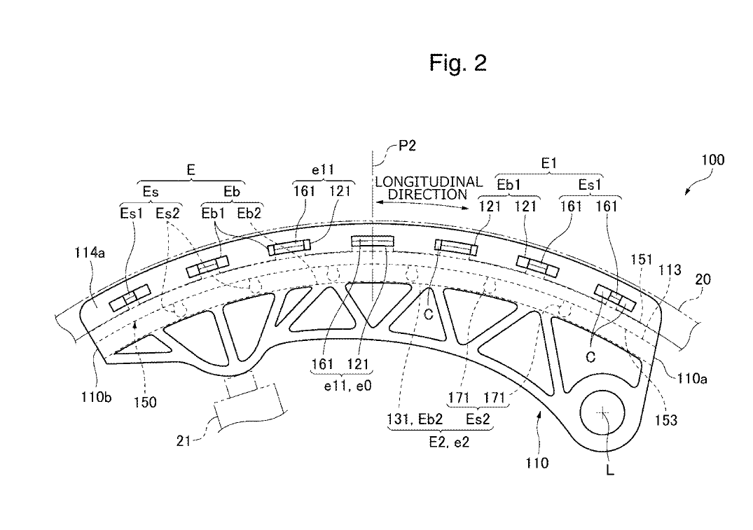

Referring to FIG. 1 and FIG. 2, the chain guide 100 (hereinafter, “guide”), or the guide for a flexible transmission member for guiding a chain 20, or the flexible transmission member, along a running direction thereof, is used in a wrapping transmission system, more specifically a timing wrapping transmission system, used in an engine, or a machine, in Embodiment 1 of the present invention.

This transmission includes an endless chain 20, a sprocket assembly formed by a plurality of sprockets on which the chain 20 is passed over, the guide 100 that forms a guide system brought into sliding contact with the chain 20 as it runs when driven by a drive sprocket included in the sprocket assembly, and a tensioner 21 that applies pressure on the guide 100. The guide 100 is a movable guide pivotally attached to an engine body, or a mounting part of the engine, to be pivotable around a pivot center line L. The tensioner 21 presses the guide 100 against the chain 20 to apply tension to the chain 20. The pivot center line L is parallel to the width direction.

The transmission is arranged inside a transmission chamber formed in the engine and lubricated with lubricating oil supplied from a lubricating system in the engine. Inside the transmission chamber is formed a lubricating oil atmosphere. In this lubricating oil atmosphere, the chain 20, guide 100, and sprockets are lubricated with oil that may be directly supplied from the lubricating system, or with oil mist present in the transmission chamber.

The guide 100 includes a base 110 extending along a longitudinal direction, and a shoe 150 supported by this base 110 and extending along the longitudinal direction. The guide 100 has a lever-like shape longer in the longitudinal direction than in the width direction. The base 110 is a one-piece molded product made of a base-forming material, and the shoe 150 is a one-piece molded product made of a shoe-forming material.

The base-forming material has a higher strength than the shoe-forming material, or a material having excellent strength and wear resistance, such as metal, composite resin, or fiber-reinforced composite resin (such as, for example, glass fiber-reinforced polyamide resin) as in this example. The shoe-forming material is a composite resin having excellent wear resistance and self-lubricating properties (for example, polyamide-based resins such as polyamide resin 66). The base-forming material and the shoe-forming material have different thermal expansion coefficients. Here, the shoe-forming material has a higher thermal expansion coefficient than the base-forming material.

Referring to FIG. 1 to FIG. 4, the base 110 has an upper flange 111, a lower flange 117, and a web 118 connecting both flanges 111 and 117.

The upper flange 111 has a support surface forming part 112 including a support surface 113 that supports the shoe 150 in the height direction, a pair of lateral rims 114 and 115 that form both ends in the width direction of the base, and a base-side mating part Eb.

The lateral rims of the base 114 and 115 have lips 114a and 115a, respectively, which extend upward relative to the support surface 113. The pair of lips 114a and 115a are positioned on both sides of the support surface 113 in the width direction to prevent meandering of the chain 20 and to restrict displacement of the shoe 150 in the width direction.

The shoe 150 includes a running surface forming part 152 having a running surface 151 brought into sliding contact with the running chain 20, and a backside 153 that contacts the support surface 113, a pair of lateral edges 154 and 155 that form both ends in the width direction of the shoe, and a shoe-side mating part Es. The pair of lateral edges of the shoe 154 and 155 are positioned on both sides of the running surface 151 in the width direction and form end faces in the width direction of the shoe 150. The pair of lateral edges of the shoe 154 and 155 are supported in the width direction by the pair of lips 114a and 115a they face in the width direction.

When assembled, the base 110 and the shoe 150 are joined together by the interlock structure E formed by the base-side mating part Eb and shoe-side mating part Es, these mating parts meshing with each other. In the guide 100 with the shoe 150 attached to the base 110, the backside 153 of the shoe 150 is supported on the support surface 113 of the base 110.

The base-side mating part Eb has a base-side lateral mating part Eb1 and a support-side mating part Eb2 formed in the support surface 113. The base-side lateral mating part Eb1 is formed to the lip 114a of one of the pair of lateral rims 114 and 115.

The shoe-side mating part Es has a shoe-side lateral mating part Es1 and a backside mating part Es2 formed in the backside 153. The shoe-side lateral mating part Es1 is formed to one of the pair of lateral edges 154 and 155, corresponding to the lateral rim of the base 114.

The base-side lateral mating part Eb1 and the shoe-side lateral mating part Es1 mesh with each other and form a lateral interlock structure E1. The support-side mating part Eb2 and the backside mating part Es2 mesh with each other and form an opposite interlock structure E2.

At least one of the base-side lateral mating part Eb1 and the shoe-side lateral mating part Es1 is an elastic mating part having one or more elastic mating elements that can deform elastically. Here, the shoe-side lateral mating part Es1 is the elastic mating part consisting only of one or more elastic mating elements. Similarly, at least one of the support-side mating part Eb2 and the backside mating part Es2 is an elastic mating part having one or more elastic mating elements that can deform elastically. Here, the backside mating part Es2 is the elastic mating part consisting only of one or more elastic mating elements.

The lateral interlock structure E1 and the opposite interlock structure E2 are a snap fit joint whereby the base 110 and the shoe 150 are joined when assembling them together, the attachment being accomplished through elastic deformation of the elastic mating elements that occurs in a moving process during assembly in which the shoe 150 is displaced relative to the base 110 in the height direction.

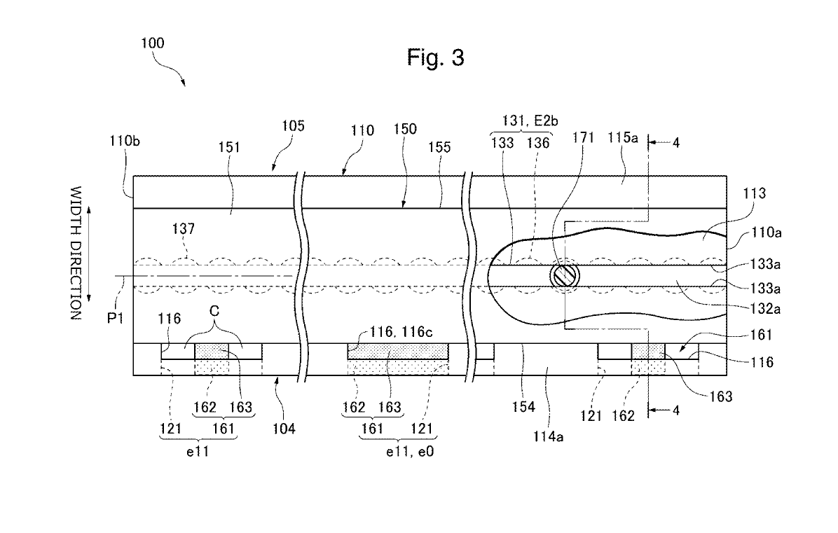

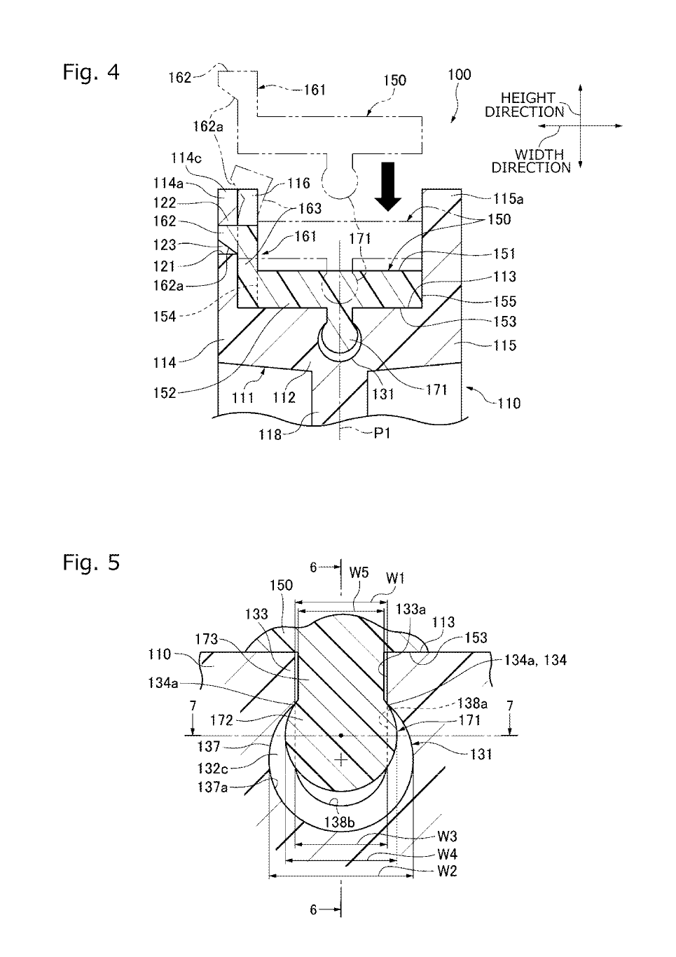

Referring mainly to FIG. 3 and FIG. 4, and also to FIG. 1 and FIG. 2 as required, the base-side lateral mating part Eb1 consists of a first predetermined number of lateral hole parts 121 as base-side lateral mating elements. The first predetermined number may be one, or any number more than one, as it is here (seven in the illustrated example). These hole parts 121 are spaced apart and arranged along the longitudinal direction. Each hole part 121 constitutes a lateral receiving part that forms a hole 123 as a lateral receiving space for accommodating a tab 162 to be described later. The hole part 121 has an upper wall 122 as a base-side lateral mating portion that engages with the tab 162.

The shoe-side lateral mating part Es1 consists of lateral mating protrusions 161 as shoe-side lateral mating elements, which are elastic mating elements, in the same number as the hole parts 121. These mating protrusions 161 are spaced apart and arranged along the longitudinal direction corresponding to the hole parts 121.

The mating protrusion 161 has the tab 162 as a shoe-side lateral mating portion that applies a mating force on the upper wall 122 of the hole part 121, and a support part 163 that supports and connects the tab 162 to the lateral edge of the shoe 154 (FIG. 3 shows the tab 162 and support part 163 with different hatchings). The tab 162 connects to the support part 163, and to the lateral edge of the shoe 154 via the support part 163, on the inner side in the width direction relative to the hole part 121.

Note, the “inner side in the width direction” in, or relative to, a part/component is the side closer to the center plane P1 in the width direction, P1 being a plane bisecting the running surface 151 in the width direction. The “outer side in the width direction” is the side farther from the center plane P1 in the width direction. In this embodiment, the center plane P1 is orthogonal to the width direction, and parallel to the imaginary plane.

“Inward direction” refers to a direction approaching the center plane P1 in the width direction, and “outward direction” refers to a direction going away from the center plane P1 in the width direction.

The support part 163 has the same width in the longitudinal direction as the tab 162, and accommodated in a fitting groove 116, which is a fit joint part formed on the inner side in the width direction of the lip 114a. The fitting groove 116 is recessed in the outward direction and extends in the height direction. The groove supports the support part 163 such as to restrict outward displacement of the support part 163 in the width direction.

The tab 162 has a follower surface 162a (see FIG. 4) that comes to contact from above with an upper end portion 114c as an abutment portion of the lip 114a as it moves during the assembly. The follower surface 162a is formed as an angled surface, and by abutting on the upper end portion 114c from above as the shoe 150 approaches the base 110 in the height direction, it causes elastic deformation in the support part 163, forcibly deflecting the support part inward relative to the hole part 121. This elastic deformation of the support part 163 causes the tab 162 to move downward as it slides on the bottom of the fitting groove 116 on the inner side in the width direction of the lip 114a in the moving process during assembly, and when the tab 162 faces the hole 123 in the width direction, the support part 163 returns to its original shape before the elastic deformation, so that the tab moves outward from the inner side in the width direction to the hole 123, and received by the hole part 121.

The hole part 121 and the mating protrusion 161 thus mate with each other, with the tab 162 fitted into the hole part 121 from the inner side in the width direction and engaging with the upper wall 122 upward in the height direction. Namely, the hole part 121 and the mating protrusion 161 constitute a snap-fit joint in which the mating protrusion 161 makes engagement after deforming elastically to join the base 110 and the shoe 150. The hole part 121 and the tab 162 are meshed with each other at a position higher than the running surface 151.

One hole part 121 and one mating protrusion 161 constitute one first lateral mating element e11. The lateral mating elements e11 are provided to only one of the pair of lateral edges 104 and 105 of the guide 100. The lateral edges 104 and 105 of the guide are formed by the lateral rims 114 and 115 of the base and the lateral edges 154 and 155 of the shoe, respectively.

The lateral interlock structure E1, or the first predetermined number of lateral mating elements e11, includes a locating and locking element e0 for determining the position in the longitudinal direction of the shoe 150 relative to the base 110. This locating and locking element e0 is located, at normal temperature, to intersect a longitudinal center plane P2 that bisects the support surface 113 or the running surface 151 in the longitudinal direction. The locating and locking element e0 may be any given one of the plurality of lateral mating elements e11 aligned along the longitudinal direction and may be, for example, the lateral mating element e11 positioned at either end in the longitudinal direction.

At normal temperature, there is hardly any gap, except for close tolerance for thermal expansion and contraction, in the longitudinal direction between the mating protrusion 161 and the hole part 121, i.e., the locating and locking element e0 in the mated state has no clearance for assembling that is provided in the conventional structure described above. The lateral interlock structure E1, in its mated state, thus restricts relative displacement between the base 110 and the shoe 150 in the longitudinal direction with the locating and locking element e0.

At normal temperature, the lateral mating elements e11 other than the locating and locking element e0 have clearances C in the longitudinal direction on both sides of the tabs 162 in the hole parts 121 for tolerating thermal expansion and contraction. The farther the respective lateral mating elements e11 apart from the locating and locking element e0, the larger the clearances.

The fitting groove 116 that receives the support part 163 of the mating protrusion 161 of the locating and locking element e0 also serves as a guide part 116c that guides the shoe 150 along the height direction to direct the support part 163 in the moving process during assembly so that the mating protrusion 161 fits into the hole part 121, whereby the shoe 150 is restricted from displacing relative to the base 110 both in the longitudinal direction and in the width direction. While this guide part 116c is formed as the fitting groove 116 in this embodiment, it may be formed as a groove dedicated for the guiding purpose separately from the fitting groove 116 in an alternative embodiment.

Moreover, there is hardly any gap in each lateral mating element e11, at normal temperature, except for close tolerance for thermal expansion and contraction, in the height direction between the tab 162 and the hole part 121 which are both small in the height direction. The lateral interlock structure E1, in its mated state, thus restricts relative displacement between the base 110 and the shoe 150 in the height direction with the lateral mating elements e11.

The tab 162 in each lateral mating element e11 is designed to increase the mating force in the height direction when thermally expanded, as it abuts on the upper wall 122 of the hole part 121 from below when mated, to press the shoe 150 against the support surface 113. More specifically, when thermally expanded, the tab 162 increases the mating force that acts upward on the upper wall 122. The reaction force from the upper wall 122 on the tab 162, i.e., on the mating protrusion 161, presses the shoe 150 against the support surface 113.

Referring now mainly to FIG. 3 and FIG. 5 to FIG. 7, and also to FIG. 2 and FIG. 4 as required, the support-side mating part Eb2 consists of a second predetermined number of groove parts 131 as support-side mating elements. The second predetermined number may be one, as it is here, or any number more than one. The groove part 131 includes a slit 133 that opens in the support surface 113 and continuously extends in the longitudinal direction, and an opposite receiving part 136 continuous with the slit 133 in the height direction and extending continuously in the longitudinal direction. The groove part 131 forms a groove space 132 that serves as an opposite receiving space for accommodating beads 172 to be described later.

The slit 133 and the receiving part 136 are located at a center position in the width direction intersecting the center plane P1 in the support surface forming part 112 or the support surface 113.

The slit 133 and the receiving part 136 are formed over the entire support surface 113 in the longitudinal direction, i.e., over the entire length of the base 110 in the longitudinal direction, and open at the chain entrance/exit end faces 110a and 110b.

The groove space 132 consists of a slit space 132a formed by the slit 133 and a receiving space 132b formed by the receiving part 136. Lubricating oil can flow into the groove space 132 through the slit space 132a, as well as through the opening of the groove space 132 at one of the end faces 110a and 110b mentioned above that will be located vertically above. The base 110 is thus cooled by the lubricating oil in the groove part 131, and the shoe 150 that is in contact with the base 110 is also cooled, so that the guide 100 has better overall cooling.

The slit 133 has a pair of slit walls 133a that are flat surfaces parallel to the imaginary plane and extending in the longitudinal direction. The groove part 131 has a groove wall 134 as a base-side opposite mating portion that engages with the bead 172. The groove wall 134 consist of a pair of wall portions 134a apart from each other in the width direction a distance equal to or larger than the lateral width W1 of the slit 133, which determines the lateral width of the slit space 132a. Each wall portion 134a continuously extending in the longitudinal direction is, for example, a boundary portion between the slit 133 and the receiving part 136 (formed by part of the slit 133 and part of the receiving part 136), or a portion of the receiving part 136 closer to the slit 133 in the height direction.

The receiving part 136 consists of a plurality of wide receiving portions 137 and a plurality of narrow receiving portions 138 having a lateral width W3 smaller than the lateral width W2 of the wide receiving portions 137. The wide receiving portions 137 and narrow receiving portions 138 are alternately arranged along the longitudinal direction. The pitch distance between wide receiving portions 137 (and narrow receiving portions 138) in the longitudinal direction is set smaller than a maximum difference in size caused by thermal expansion and a maximum difference in size caused by thermal contraction that could occur in the range of temperatures at which the guide 100 is used.

The wall 137a of the wide receiving portion 137 is spherical having the center in the center plane P1. The pair of side walls 138a of the narrow receiving portion 138 are flat surfaces tangential to the cylindrical bottom wall 138b having a smaller radius than the radius of the wall 137a, and extend parallel to the imaginary plane.

The receiving space 132b consists of a spherical wide receiving space 132c formed by the wide receiving portion 137 and a narrow receiving space 132d formed by the narrow receiving portion 138. The lateral width W3 of the narrow receiving portion 138, which is the lateral width of the narrow receiving space 132d, equals to or more than the lateral width W1 of the slit 133, and smaller than the lateral width W2 of the wide receiving portion 137, which is the lateral width of the wide receiving space 132c. In this example, the lateral width W3 of the narrow receiving portion 138 is equal to the lateral width W1 of the slit 133.

The backside mating part Es2 consists of a third predetermined number of opposite mating protrusions 171 as backside mating elements, which are elastic mating elements. The third predetermined number may be one or any number more than one. Here it is plural, unlike the second predetermined number.

These mating protrusions 171 are spaced apart from each other and arranged along the longitudinal direction (FIG. 2) to be each located between the hole parts 121 (or tabs 162) adjacent each other in the longitudinal direction.

The mating protrusion 171 includes a bead 172 as a shoe-side opposite mating portion that applies a mating force upward against the groove walls 134 when fitted in the wide receiving portion 137 through the slit 133, and a support part 173 that supports and connects the bead 172 to the backside 153.

The slit 133 has a lateral width W1 smaller than the maximum lateral width W4 of the bead 172 and larger than the lateral width W5 of the support part 173. The lateral width W4 of the bead 172 is smaller than the lateral width W2 of the wide receiving portion 137 and larger than the lateral width W3 of the narrow receiving portion 138.

Therefore, the wide receiving portion 137 is dimensioned in the width direction such that there is a clearance in the width direction between the wide receiving portion 137 and the bead 172 fitted therein. The narrow receiving portion 138 is dimensioned in the width direction such that the bead 172 contacts it in the width direction. Here, when the bead 172 is fitted in the narrow receiving portion 138, it is elastically deformed and compressed in the width direction by both side walls 138a.

When the shoe 150 moves closer to the base 110 in the height direction in the moving process during assembly (FIG. 4), the bead 172 comes down toward the slit space 132a and is pressed into the slit space 132a. The abutment in the width direction between the pair of slit walls 133a of the slit 133 and the bead 172 at this time causes elastic deformation in the bead and compresses it in the width direction. As the shoe 150 moves further down, when the bead 172 moves past the slit 133, it returns to its original shape before the elastic deformation inside the receiving part 136, in this case in the wide receiving portion 137, and fits in the receiving part 136. The groove part 131 and the mating protrusions 171 thus mesh with each other, with the beads 172 applying an upward mating force in the height direction to the groove walls 134. Namely, the groove part 131 and the mating protrusions 171 constitute a snap-fit joint in which the mating protrusions 171 make engagement after deforming elastically to join the base 110 and the shoe 150.

One groove part 131 and one each mating protrusion 171 constitute one opposite mating element e2.

At normal temperature, there is hardly any clearance in the height direction, not even tolerance for thermal expansion and contraction, between the bead 172 and the groove walls 134 in the opposite interlock structure E2 in the mated state, i.e., in each opposite mating element e2. The opposite interlock structure E2, in its mated state, thus restricts relative displacement between the base 110 and the shoe 150 in the height direction, as well as retains the bead 172 in the groove part 131.

At normal temperature, in each opposite mating element e2 in the mated state, the bead 172 is in contact with both side walls 138a of the narrow receiving portion 138 when fitted therein. Therefore, displacement of the shoe 150 in the longitudinal direction due to the movement or vibration of the running chain 20 is suppressed by the friction generated between the beads 172 and both side walls 138a. Since the beads 172 located in the narrow receiving portions 138 are elastically deformed as they are compressed in the width direction by both side walls 138a, this friction is increased to ensure the constraint on the shoe 150 in the longitudinal direction.

The bead 172 is designed to increase the mating force in the height direction when thermally contracted, as it abuts on the groove walls 134 from below when mated, to press the shoe 150 against the support surface 113. More specifically, when thermally contracted, the bead 172 increases the mating force that acts upward on the groove walls 134. The reaction force from the groove walls 134 on the bead 172, i.e., on the mating protrusion 171, presses the shoe 150 against the support surface 113.

The bead 172 can move inside the wide receiving portion 137 and the narrow receiving portion 138 in accordance with the amount of thermal expansion or contraction of the base 110 and the shoe 150 when the guide 100 undergoes thermal expansion/contraction. More specifically, in the opposite mating elements e2 in the mated state, when thermal expansion or contraction occurs, the beads 172 fitted in the receiving part 136 can move in one or more wide receiving portions 137 or in one or more narrow receiving portion 138 in the longitudinal direction. For example, when the amount of thermal expansion/contraction is increased to a certain extent, the beads 172 fitted in the wide receiving portions 137 move to another wide receiving portion 137 adjacent to the ones in which they are fitted in the longitudinal direction via the narrow receiving portions 138. At this time, the shoe 150 expands or contracts in the longitudinal direction relative to the base 110 against the friction resistance between the beads 172 and the pair of side walls 138a of the narrow receiving portions 138.

Referring now mainly to FIG. 4, and also to FIG. 2, FIG. 3, and FIG. 5 as required, the method of attaching the shoe 150 to the base 110 will be described.

First, the shoe 150 is brought to a position above the base 110, which is located to a designated assembling position. Next, the shoe 150 is moved along the height direction, for example parallel thereto, downward, or a direction in which it approaches the base 110.

In the moving process during assembly, the support parts 163 of the lateral mating protrusions 161 move downward within the respective fitting grooves 116. The guide part 116c of the locating and locking element e0 guides the support part 163 in the longitudinal direction and in the width direction, so that the shoe 150 is not displaced in the longitudinal direction and in the width direction. Therefore, in the respective lateral mating elements e11 other than the locating and locking element e0, the support parts 163 are guided in the width direction and move downward within the respective fitting grooves 116.

The abutment between the follower surfaces 162a and upper end portions 114c of the lip 114a causes elastic deformation in the support parts 163 and deflects them inward relative to the lip 114a and the hole parts 121 during the process in which the shoe 150 approaches the base 110 in the height direction. With the support parts 163 still deflected, and the tabs 162 contacting the bottom of the fitting grooves 116, the shoe 150 approaches the base 110 further. At this time the beads 172 start to enter the slit 133, and as the shoe 150 moves closer to the base 110, the beads 172 are pressed into the slit 133 while being compressed in the width direction by the pair of slit walls 133a.

When the shoe 150 comes to a position where its backside 153 contacts the support surface 113, the tabs 162 fit in the hole parts 121 from the inner side in the width direction, while the beads 172, having passed through the slit 133, fit into the wide receiving portions 137 of the receiving part 136.

The lateral interlock structure E1 thus locks, with the respective lateral mating elements e11, i.e., respective hole parts 121 and mating protrusions 161 meshing with each other, and the opposite interlock structure E2 locks, with the respective opposite mating elements e2, i.e., the groove part 131 and mating protrusions 171 meshing with each other, whereby the base 110 and the shoe 150 are joined together.

In this embodiment, the respective opposite mating protrusions 171 are positioned in the longitudinal direction such that their beads 172 will fit in corresponding wide receiving portions 137 in the moving process during assembly. Since the beads 172 fit in the wide receiving portions 137 when attaching the shoe 150 to the base 110, the assembling load (pressure required for the assembly) to attach the shoe 150 to the base 110 is reduced as compared to when the beads 172 are received in narrow receiving portions 138. Accordingly the shoe 150 can be assembled to the base 110 more easily.

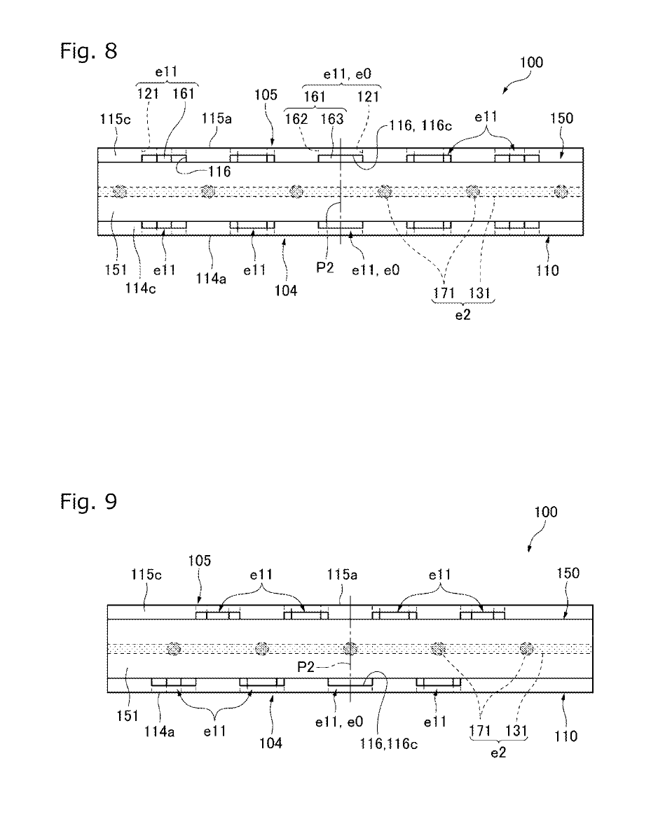

Next, a variation example of Embodiment 1, and Embodiments 2 to 4 of the present invention will be described with reference to FIG. 8 to FIG. 16. This variation example and Embodiments 2 to 4 differ partly from Embodiment 1, but otherwise configured basically the same. Therefore, same parts are only given the reference numerals in the drawings to omit or simplify the description thereof, and the difference will mainly be explained. Parts and components in Embodiment 2 or 3 that are identical to or corresponding to those of Embodiment 1 or 2 will be termed the same and given reference numerals beginning with 2 for Embodiment 2, numerals beginning with 3 for Embodiment 3 instead of 1 or 2 for Embodiment 1 or 2, and numerals beginning with 4 for Embodiment 4, with the same last two digits as those of Embodiment 1.

Referring to FIG. 8 and FIG. 9, in a variation example of Embodiment 1, the chain guide 100 has the first predetermined number of lateral mating elements e11 provided to the pair of lips 114a and 115a. These lateral mating elements e11 may be arranged symmetrical about the center plane P1 as shown in FIG. 8, or in a zigzag layout as shown in FIG. 9.

The fitting groove 116 of the lateral locating and locking element e11 in the lip 115a serves as the guide part 116c. In the moving process during assembly, the follower surface 162a of the tab 162 of the mating protrusion 161 (FIG. 4) abuts on the upper end portion 115c as an abutment portion of the lip 115a of the lateral edge 105 of the guide.

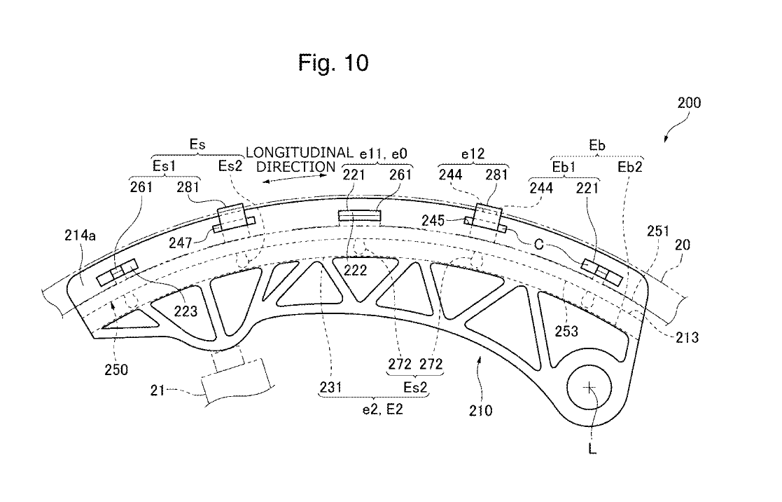

Referring to FIG. 10 to FIG. 12, in the chain guide 200 according to Embodiment 2, the base-side lateral mating part Eb1 consists of one, or as in this case, a plurality of, lateral hole parts 221 as first base-side lateral mating elements, and one, or as in this case, a plurality of, lateral fit-in-joints 244 as second base-side lateral mating elements.

The shoe-side lateral mating part Es1 consists of lateral mating protrusions 261 as first shoe-side lateral mating elements, which are elastic mating elements, and lateral mating protrusions 281 as second shoe-side lateral mating elements, which are elastic mating elements.

The lateral fit-in-joints 244 are provided to both lips 214a and 215a, which are the protruded portions of the lateral rims 214, 215 of the base, respectively. Each fit-in-joint 244 includes a lateral recess 245 formed on the outer side in the width direction of the lip 214a or 215a as a lateral receiving part that forms a recessed space 247, or a lateral receiving space, and a distal end 248 positioned above the recess 245 and makes engagement with a bridge 285 to be described later upwards.

The upper wall 246, which is a wall of the recess 245 of the fit-in-joint 244, constitutes the first base-side lateral mating portion, while the distal end 248, which is also the upper end portion of the lip 214a or 215a, constitutes the second base-side lateral mating portion.

The lateral mating protrusion 281 includes a tab 282 that applies a mating force upwards on the upper wall 246 of the recess 245, and a support part 283 that supports and connects the tab 282 with the lateral edge of the shoe 254 or 255.

The support part 283 is hook-shaped and includes an inner support part 284 extending upwards along the inner side in the width direction of each lip 214a or 215a, a bridge 285 extending in the width direction such as to cover the distal end 248 from above, and an outer support part 286 extending from the bridge 285 downwards along the outer side in the width direction of each lip 214a or 215a. The support part 283 of the mating protrusion 281 thus wraps around the distal end 248.

The tab 282 at the tip of the outer support part 286 is the first shoe-side lateral mating portion that engages with the recess 245, and has a follower surface 282a. The follower surface 282a abuts on the distal end 248 to cause an inward elastic deformation or deflection in the inner support part 284 as the shoe 250 moves downward toward the base 210 to allow the tab 282 to fit in the recess 245, as in Embodiment 1.

The engagement between the recess 245 and the tab 282, and the engagement between the distal end 248 and the bridge 285 are both located at a position higher than the running surface 251.

The tab 282 of the mating protrusion 281 is the first shoe-side lateral mating portion that engages with the recess 245, which abuts on the upper wall 246 of the recess 245 from below in the mated state, and increases the mating force on the upper wall 246 when it expands thermally. The bridge 285 is the second shoe-side lateral mating portion that engages with the distal end 248, which abuts on the upper end surface of the distal end 248 from above in the mated state, and increases the mating force on the distal end 248 in cooperation with the opposite interlock structure E2 when it contracts thermally.

One fit-in-joint 244 and one mating protrusion 281 constitute one second lateral mating element e12. Thus, in the chain guide 200, the lateral interlock structure E1 is formed by one, or as in this case a plurality of, first lateral mating elements e11, and one, or as in this case a plurality of, second lateral mating elements e12.

These first and second lateral mating elements e11 and e12 are arranged in a zigzag layout, or alternately arranged along the longitudinal direction, in the pair of lateral edges 204 and 205 of the guide.

The opposite interlock structure E2 consists of the opposite mating element e2.

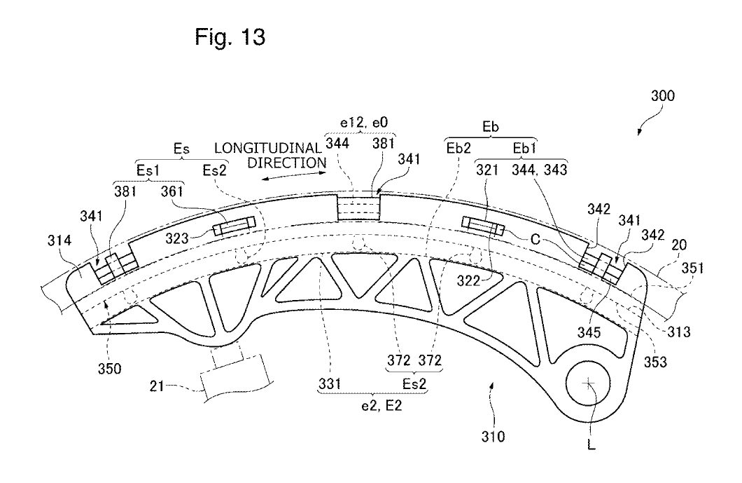

Referring to FIG. 13 to FIG. 15, the guide 300 according to Embodiment 3 has one, or as in this case a plurality of, notches 341 recessed downwards in both lips 314a and 315a. Each notch 341 is formed by a pair of stepped portions 342 provided in the height direction and spaced apart from each other in the longitudinal direction, and a bottom part 343 continuous with the stepped portions 342 and extending in the longitudinal direction. The bottom part 343 forms a lateral fit-in-joint 344 as the base-side lateral mating element that forms the base-side lateral mating part Eb1. The bridge 385 is located inside the notch 341.

The follower surface 382a of the tab 382 abuts on the distal end 348, which is an upper end portion of the bottom part 343, to cause an inward elastic deformation or deflection in the inner support part 384 as the shoe 350 moves downward toward the base 310 to allow the tab 382 to fit in the recess 345.

The first and second lateral mating elements e11 and e12 are arranged symmetrical about the center plane P1, and alternately arranged along the longitudinal direction, in the pair of lateral edges 304 and 305 of the guide.

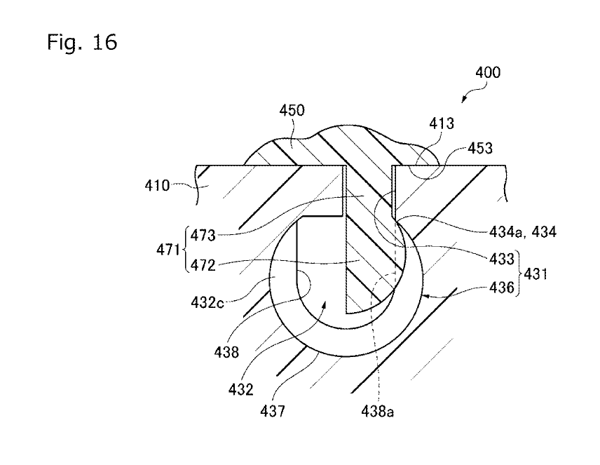

Referring to FIG. 16, in the guide 400 according to Embodiment 4, the opposite mating protrusion 471 includes a semi-spherical bead 472 having a spherical surface only on one side thereof in the width direction as the shoe-side opposite mating portion. Here, the mating protrusions 471 that form the opposite mating element e2 are all semi-spherical beads 472, or first semi-spherical beads, having a spherical surface only on one side thereof (right side in FIG. 16) in the width direction.

In an alternative embodiment, the semi-spherical beads 472 of the opposite mating element e2 may all be second semi-spherical beads that have a spherical surface on the other side (left side in FIG. 16) in the width direction, or, the opposite mating element e2 may consist of one or more first semi-spherical beads and one or more second semi-spherical beads.

Below, the various changes made to part of the structures of the embodiments and variations thereof described above will be explained.

The opposite interlock structure may have a configuration that increases the mating force in the height direction when thermally expanded, and the lateral interlock structure E1 may have a configuration that increases the mating force in the height direction when thermally contracted. In this case, the opposite interlock structure would be configured, for example, to have the bead engaging with the groove part such as to increase the mating force in the height direction on the receiving part with an amount of thermal expansion of the bead in the width direction.

In the opposite mating element in the mated state at normal temperature, the bead inside the receiving part may be in contact with the narrow receiving portion even when located in the wide receiving portion, not to mention when located in the narrow receiving portion, or, the bead may always be in contact with the receiving part in the width direction inside the receiving part. The friction between the beads and receiving parts will then restrict displacement of the shoe in the longitudinal direction due to the movement or vibration of the running chain, which will reduce the impact of collision between the base-side lateral mating element and the shoe-side lateral mating element, which in turn reduces noise and wear resulting from the collision, and prevents looseness of the shoe.

The groove part or support-side mating element of the opposite mating element may be provided locally at one or more locations over a certain area in the longitudinal direction. The groove part, opposite mating protrusions, support-side mating elements, or backside mating elements may be formed at a plurality of different positions in the width direction.

The opposite mating element can also serve as the locating and locking element.

The base-side lateral mating element may consist only of the lateral mating protrusions, or a combination of lateral receiving parts and lateral mating protrusions, and the shoe-side lateral mating element may consist only of the lateral receiving parts, or a combination of lateral mating protrusions and lateral receiving parts. The support-side lateral mating element may consist only of the opposite mating protrusions, or a combination of opposite receiving parts and opposite mating protrusions, and the backside mating element may consist only of the opposite receiving parts, or a combination of opposite mating protrusions and opposite receiving parts.

The lateral mating elements of the guide may all consist only of the second lateral mating elements of Embodiment 2, or consist only of the second lateral mating elements of Embodiment 3.

The base-forming material may have a higher thermal expansion coefficient than the shoe-forming material.

What is claimed is:

1. A guide for a flexible transmission member, comprising a base having a support surface and a pair of lateral rims positioned on both sides of the support surface in a width direction, and a shoe having a running surface in sliding contact with a running flexible transmission member and a pair of lateral edges positioned on both sides of the running surface in the width direction, the base and the shoe being joined together by an interlock structure formed by a base-side mating part of the base and a shoe-side mating part of the shoe so that the support surface supports the shoe on a backside of the shoe, wherein
the base-side mating part includes one or more base-side lateral mating parts provided in the lateral rims of the base, and a support-side mating part provided in the support surface,
the shoe-side mating part includes one or more shoe-side lateral mating parts provided in the lateral edges of the shoe, and a backside mating part provided in the backside,
the base-side lateral mating part and the shoe-side lateral mating part that mesh with each other form a lateral interlock structure,
the support-side mating part and the backside mating part that mesh with each other form an opposite interlock structure,
the lateral interlock structure in the meshed state restricts relative displacement between the base and the shoe at least in a longitudinal direction of the longitudinal direction and a height direction,
the opposite interlock structure in the meshed state restricts relative displacement between the base and the shoe in the height direction,
at least one of the base-side lateral mating part and the shoe-side lateral mating part and at least one of the support-side mating part and the backside mating part are elastic mating parts having one or more elastically deformable elastic mating elements, and
the lateral interlock structure and the opposite interlock structure are a snap-fit joint in which the meshed state is achieved through elastic deformation of the elastic mating elements that occurs in a moving process during assembly in which the shoe moves relative to the base in the height direction to be attached to the base.

2. The guide for a flexible transmission member according to claim 1, wherein one of the lateral interlock structure and the opposite interlock structure is configured to press the shoe against the support surface by increasing a mating force in the height direction when the base and the shoe expand thermally, and the other structure is configured to press the shoe against the support surface by increasing the mating force in the height direction when the base and the shoe contract thermally.

3. The guide for a flexible transmission member according to claim 1, wherein at least one of the lateral rims of the base includes a guide part that guides the shoe along the height direction while restricting displacement of the shoe relative to the base in the longitudinal direction and in the width direction in the moving process during assembly.

4. The guide for a flexible transmission member according to claim 1, wherein the base-side lateral mating part is formed by one or more base-side lateral mating elements, and
the shoe-side lateral mating part is formed by shoe-side lateral mating elements as the elastic mating elements in a same number as the base-side lateral mating elements,
the shoe-side lateral mating element each includes a first mating portion and a second mating portion that mesh with the base-side lateral mating elements at a position higher than the running surface,
the first mating portion in the meshed state abuts on the base-side lateral mating element from below to increase a mating force on the base-side lateral mating element when the base and the shoe expand thermally, and
the second mating portion in the meshed state abuts on the base-side lateral mating element from above to increase a mating force on the base-side lateral mating element in cooperation with the opposite interlock structure when the base and the shoe contract thermally.

5. The guide for a flexible transmission member according to claim 4, wherein the pair of lateral rims of the base include notches recessed downwards, each notch being formed by a pair of stepped portions provided in the height direction and spaced apart from each other in the longitudinal direction, and a bottom part continuous with the pair of stepped portions and extending in the longitudinal direction,
the bottom part is the base-side lateral mating element, and
the second mating portion that meshes with the base-side lateral mating element at a position higher than the first mating portion is located inside the notch.

6. The guide for a flexible transmission member according to claim 4, wherein the base-side lateral mating part is formed by one or more first base-side lateral mating elements and second base-side lateral mating elements that are the base-side lateral mating elements, and
the shoe-side lateral mating part is formed by first shoe-side lateral mating elements as the elastic mating elements in a same number as the first base-side lateral mating elements, and second shoe-side lateral mating elements that are the shoe-side lateral mating elements,
the first shoe-side lateral mating element each meshes with the first base-side lateral mating element in the height direction from an inner side in the width direction, and abuts on the first base-side lateral mating element from below in the meshed state to increase the mating force on the first base-side lateral mating element when the base and the shoe expand thermally, and
the first mating portion meshes with the second base-side lateral mating element in the height direction from an outer side in the width direction.

7. The guide for a flexible transmission member according to claim 1, wherein the support-side mating part is formed by one or more groove parts including a slit forming a slit space open to the support surface and extending in the longitudinal direction, and a receiving part continuous with the slit in the height direction and extending in the longitudinal direction,
the receiving part is formed by a plurality of wide receiving portions and a plurality of narrow receiving portions having a smaller lateral width than the wide receiving portions, the wide receiving portions and the narrow receiving portions being arranged alternately along the longitudinal direction,
the backside mating part is formed by one or more mating protrusions as the elastic mating elements including a shoe-side opposite mating portion received in the receiving part, and a support part connected to the backside and supporting the shoe-side opposite mating portion,
the slit has a smaller lateral width than the shoe-side opposite mating portion,
the narrow receiving portion has a size in the width direction that is set such as to allow the shoe-side opposite mating portion received in the narrow receiving portion to contact the narrow receiving portion in the width direction, and
the shoe-side opposite mating portion, when positioned in the receiving part after elastic deformation by contact with the slit in the moving process during assembly, restricts upward movement of the shoe by engagement with the groove part, and is movable in the longitudinal direction inside the one or more wide receiving portions or the one or more narrow receiving portions when the shoe expands or contracts thermally.

8. The guide for a flexible transmission member according to claim 7, wherein the groove part is formed continuously over an entire length of the support surface in the longitudinal direction,
the wide receiving portion forms a spherical wide receiving space, and
the shoe-side opposite mating portion is a semi-spherical bead having a spherical surface on one side thereof in the width direction.
